(19) United States
(12) Patent Application Publication
(10) Pub. No.: US 2026/0349977 A1
(43) Pub. Date: Nov. 5, 2026

(54) ARTIFICIAL INTELLIGENCE GENERATION OF A DATA VALIDATION PROGRAM TO VALIDATE AND TRANSFORM DATA

(71) Applicant: INTERNATIONAL BUSINESS MACHINES CORPORATION, ARMONK, NY (US)

(72) Inventors: Yu Ying YY Wang, Xi‘an (CN); Jian Dong Yin, Beijing (CN); Wang Hu Dang, Xi'an City (CN); Yao Chen, ShiJiaZhuang (CN); Fan Wang, Shanghai (CN); Zhi Yong Jia, XI'AN (CN)

(21) Appl. No.: 19/195,266

(22) Filed: Apr. 30, 2025

(51) Int. Cl. G06F 16/215; G06F 16/23; G06N 3/0475

(52) U.S. Cl. CPC G06F 16/215; G06F 16/2365; G06N 3/0475

(57) ABSTRACT

Provided are a method, system, and computer program product for artificial intelligence generation of a data validation program. Data requirements are received comprising a description of data to be validated. Artificial intelligence processes the data requirements to generate task plans. The task plans provide a description of data validation operations to perform on the data and comprise a first task plan and a second task plan. The artificial intelligence processes descriptions of predefined functions to determine a predefined function that performs operations specified for the first task plan. The artificial intelligence processes the second task plan to generate function code to validate the data to be validated. The predefined function for the first task plan and the function code for the second task plan are executed to validate the data.

### BACKGROUND OF THE INVENTION

The present invention relates to a computer implemented method, system, and computer program product for artificial intelligence generation of a data validation program.

Enterprises develop data validation programs to perform data verification, validation, and cleaning of data records to analyze content for insights, generate alerts of problems and inconsistencies in the data, and clean and correct data. Enterprises often engage a data scientist or expert in a domain of the data to analyze the enterprise data and develop validation programs to verify and correct enterprise data.

### SUMMARY

Provided are a method, system, and computer program product for artificial intelligence generation of a data validation program. Data requirements are received comprising a description of data to be validated. Artificial intelligence processes the data requirements to generate task plans. The task plans provide a description of data validation operations to perform on the data and comprise a first task plan and a second task plan. The artificial intelligence processes descriptions of predefined functions to determine a predefined function that performs operations specified for the first task plan. The artificial intelligence processes the second task plan to generate function code to validate the data to be validated. The predefined function for the first task plan and the function code for the second task plan are executed to validate the data.

### BRIEF DESCRIPTION OF THE DRAWINGS

FIG. 1 illustrates a computing environment to generate a data validation program and execute the data validation program.

FIG. 2 illustrates an embodiment of a data requirement for a data entity.

FIG. 3 illustrates an example of a data validation task.

FIG. 4 illustrates an example of data requirements for a data set.

FIG. 5 illustrates an example of a data report outputted during execution of the generated data validation program.

FIG. 6 illustrates an embodiment of operations performed to generate data validation tasks and a data validation program.

FIG. 7 illustrates an embodiment of operations to generate validation tasks using prompts to a generative AI model.

FIG. 8 illustrates an embodiment of operations to execute a data validation program.

FIG. 9 depicts a computing environment in which the components of FIG. 1 may be implemented.

### DETAILED DESCRIPTION

Described embodiments provide improvements to computer technology for generating data validation and cleaning programs to validate and transform data having different data requirements. Described embodiments utilize generative AI models to process data requirements to generate data validation and cleaning tasks to perform validation and cleaning operations for specific data sets. Described embodiments provide an architecture and data structures for interacting with generative AI models based on data requirements for data entities in the data to validate to generate data validation tasks for the data validation and cleaning operations to perform. The generated data validation tasks are then processed to generate function code to perform the validation and checking operations of the data validation tasks. In this way, described embodiments provide improvements to computer technology to automate the process for generating the data validation program based on the specific data requirements of data to validate.

In one implementation, described embodiments utilize a prompt generator to generate a series of prompts to interact with task generator artificial intelligence (AI), such as a generative AI model, to generate tasks to validate and clean data based on the data requirements, determine predefined functions to implement the tasks, update information and descriptions on the tasks, generate code functions to implement tasks, and/or further revise the tasks. The prompt generator provides an improved computer architecture to interact with the task generator to automate the generation of data validation programs for data having different data requirements.

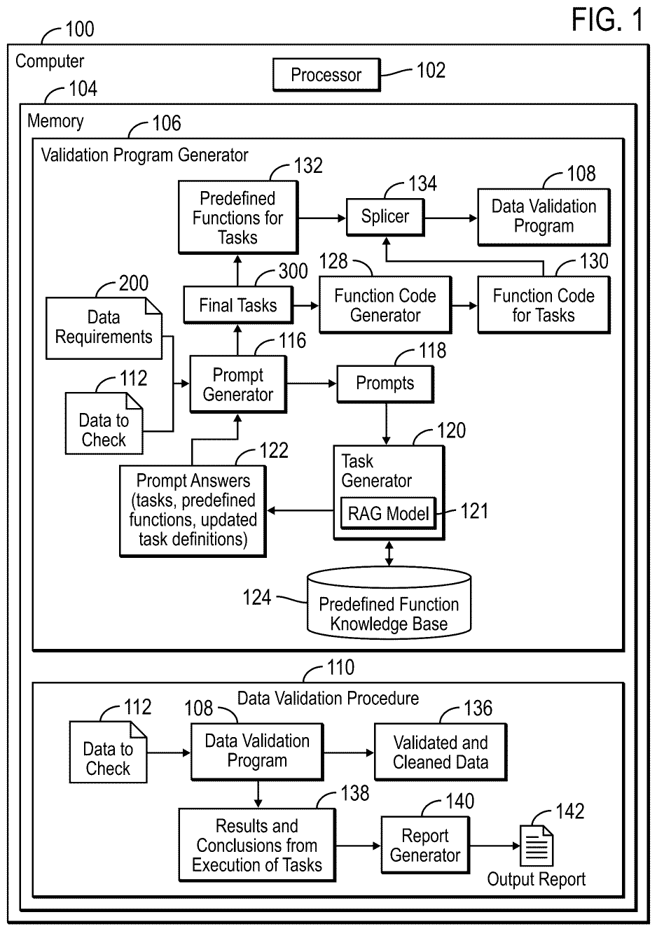

FIG. 1 illustrates an embodiment of a computer system 100 in which embodiments are implemented. The system 100 includes a processor 102 and a main memory 104. The main memory 104 includes a validation program generator 106 to generate a data validation program 108 that is used by a data validation procedure 110 to validate and clean data to check 112. The validation program generator 106 receives data requirements 200 having requirements of data entities in the data to check 112 and the data to check 112.

The term data validation as used herein refers in at least some embodiments to data verification to confirm whether data complies with data requirements and transformations and to data cleaning operations of data to modify data to confirm to data requirements. Data validation operations may include, without limitation, data cleaning, natural language processing to understand context to identify and correct errors and/or inconsistencies in the data, complex transformations of the data entities, providing natural language interfaces to allow users to interact with the data validation, generating documentation including descriptions of data validation, and providing insights into logic of data validation operations.

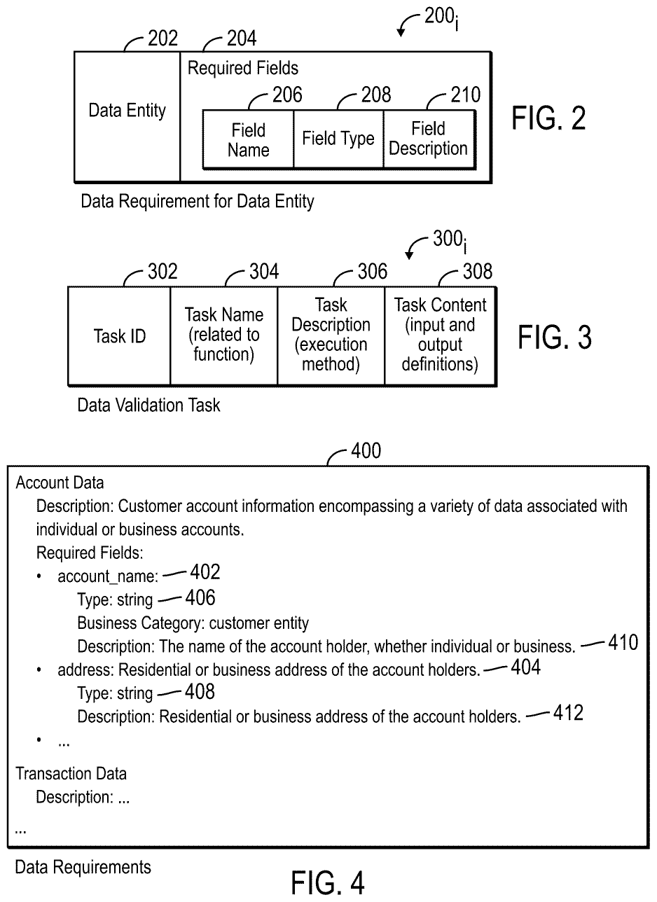

FIG. 2 illustrates an embodiment of a data requirement for a data entity 200i, also referred to as “data”, where the data requirements 200 may have multiple instances of data requirements 200; for the different data entities in the data 112. The data requirements for a data entity 200; may include a data entity identifier 202 and required fields 204 of field definitions. Required fields may include a field name 206, a field type 208 indicating a type of the field, such as string, table, data structure, object, number, etc., a field description 210 providing a textual description of the data field, and additional information, such as data structure definitions, encoding formats, logical value range, etc.

FIG. 4 provides an example of data requirements 400 for two different data entities: account name 402 and address 404. The name 402, 404, type 406, 408, and descriptions 410, 412 of these two data entities are provided. Name 402, type 406, and description 410 are provided for the account name (402) data entity. Name 404, type 408, and description 412 are provided for the address (404) data entity.

As shown in FIG. 1, in at least some embodiments, a prompt generator 116 generates prompts 118 comprising queries to a task generator 120 to generate prompt answers 122. The task generator 120 may comprise a generative machine learning model or generative Artificial Intelligence (AI) model, also referred to as artificial intelligence, and include additional architectures such as transforms to model relationships in data and generate outputs based on input prompts. In certain embodiments, the task generator 120 may comprise a large language model (LLM).

The generated prompts 118 are input into the task generator 120 to cause the task generator 120 to produce the prompt answers 122 as outputs. The prompt answers 122, depending on what is requested by the prompts 118, in various embodiments comprise tasks to perform data validation of the data as defined in the data requirements, also referred to as task plans, identification of predefined functions in a predefined function knowledge base 124 to perform the operations specified by the tasks, updated task definitions, etc. Examples of predefined functions include data fields type identification, data fields value description, data type identification according to standard requirement, human entity fields identification, data fields mapping with standard requirement, foreign key identification, data merging or association, etc.

The task generator 118 may implement a retrieval augmented generation (RAG) model 121 to fetch information on predefined functions from the predefined function knowledge base 124 to determine predefined functions that perform operations specified by the generated tasks. Retrieval augmented generation (RAG) allows generative machine learning models, also referred to as generative AI models, to build on a specialized body of knowledge to answer questions in more accurate way. In a RAG model, the generative AI model is asked to respond to a question by “browsing through the content in a book”, as opposed to trying to remember facts from memory. As the name suggests, RAG has two phases: retrieval and content generation. In the retrieval phase, algorithms search for and retrieve snippets of information relevant to the user's prompt or question. The RAG model 121 has access to the predefined function knowledge base 124 and uses this information to check for suitability for use of the predefined functions with the particular data to check 112. In the generative phase, the task generator 120 draws from the prompt 118, information on predefined functions from the RAG model 121, and its internal representation of its training data to synthesize an engaging answer 122 tailored to the request provided by the prompt. The RAG model 121 further retrieves information from the predefined function knowledge base 124 and augments the prompt 118 with this information. Thereafter the task generator 120 receives the augmented prompt and performs improved task plan generation due to having the benefit of the external knowledge obtained from the predefined function knowledge base 124.

In various embodiments, the prompt answers 122 are processed by the prompt generator 116 to generate further prompts 118 for the task generator 120 to generate further prompt answers 122. Such further prompts 118 include in various embodiments instructions for the task generator 120 to determine whether to merge tasks if they have the same functions with respect to the same data entities or split a task into subtasks if a task is defined as performing multiple data validation operations. If the prompt generator 116 determines the defined tasks are complete, then the final tasks 300 are output. In various embodiments, a function code generator 128 generates function code 130 for final tasks 300 which do not have a predefined function as determined from the knowledge base 124 to perform the task operations.

A function code refers to a block of code in programming that performs a specific task. Functions are defined by a name, can take parameters, and may return a value after processing input data. Functions allow for code reusability and enable programmers to call the same block of code multiple times without rewriting the code. Essentially, functions help organize code into manageable sections and make the code easier to use and maintain. The function code generator 128 is a generative machine learning model that has been trained to perform one or more programming code-related tasks and in some embodiments one or more code understanding tasks such as function naming, variable naming, code summarization, code recommendation, code completion, defect detection, vulnerability detection, and bug fixing.

A task 300i, as shown in FIG. 3, in the depicted embodiment includes a task ID 302, a task name 304, which may be related to the function of the task, a task description 306, including information about the execution method for the task, and task content 308, including the input and output definitions.

The predefined function and function code generated for the tasks, when executed, perform data validation operations including one or more of data cleaning, natural language processing to understand context to identify and correct errors and/or inconsistencies in the data, complex transformations of the data entities, providing natural language interfaces to allow users to interact with the data validation, generating documentation including descriptions of data validation and providing insights into logic of data validation operations.

A splicer 134 forms a data validation program 108 by integrating the function code 130 and predefined functions 132 for the tasks 300. The predefined functions 132 are from the predefined functions 124.

In various embodiments, a data validation procedure 110 inputs the data to check 112 into the data validation program 108 to execute the generated function code and predefined functions to perform the task operations to generate validated and cleaned data 136 from the data to check 112. In some embodiments, the data validation program 108 further generates results and conclusions 138 from execution of the tasks and inputs these results and conclusions 138 into a report generator 140 so that, in response, the report generator 140 generates an output report 142. In some embodiments, the output report 142 summarizes in a human understandable format the overall data processing flow and includes conclusions for each step, indicating whether the data meets the specified requirements. If discrepancies are found, the report highlights the gaps in the data, providing valuable insights for users.

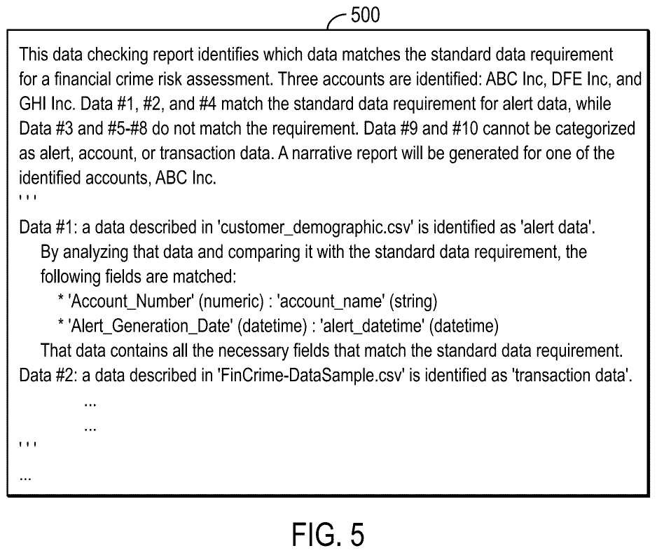

FIG. 5 illustrates an example 500 of the output report 142. The report 500 provides information on whether data entities in three accounts, “ABC”, “DFE”, and “GHI” satisfy data requirements.

The memory 104 may comprise suitable volatile or non-volatile memory devices known in the art. For instance, the memory 104 may comprise one or more memory devices volatile or non-volatile, such as a Dynamic Random Access Memory (DRAM), a phase change memory (PCM), Magnetoresistive random-access memory (MRAM), Spin Transfer Torque (STT)-MRAM, SRAM storage devices, DRAM, a ferroelectric random-access memory (Efram), nanowire-based non-volatile memory, and Direct In-Line Memory Modules (DIMMs), NAND storage, e.g., flash memory, Solid State Drive (SSD) storage, non-volatile RAM, etc.

Generally, program modules, such as the program components 106, 108, 110, 116, 120, 124, 128, 132, 134, 140, among others, may comprise routines, programs, objects, components, logic, data structures, and so on that perform particular tasks or implement particular abstract data types. The program components and hardware devices of the system 100 may be implemented in one or more computer systems, where if they are implemented in multiple computer systems, then the computer systems may communicate over a network.

The program components 106, 108, 110, 116, 120, 124, 128, 132, 134, 140, among others, may be accessed by the processor 102 from the memory 104 to execute.

Alternatively, some or all of the program components 106, 108, 110, 116, 120, 124, 128, 132, 134, 140, may be implemented in separate hardware devices, such as Application Specific Integrated Circuit (ASIC), Field Programmable Gate Arrays (FPGAs) and other hardware devices.

The functions described as performed by the program components 106, 108, 110, 116, 120, 124, 128, 132, 134, 140, among others, may be implemented as program code in fewer program modules than shown or implemented as program code throughout a greater number of program modules than shown.

FIG. 1 shows the validation program generator 106 and data validation procedure 110 on the same computer 100. In further embodiments, the validation program generator 106 may be located on one computer system and the generated data validation program may be distributed to other computer systems to validate data sets.

Certain of the components, such as the prompt generator, task generator, RAG model, function code generator, and report generator may be implemented as generative machine learning models or generative AI, including large language models (LLMs).

Alternatively, other types of machine learning algorithms may be used, such as deep learning algorithms and natural language processor (NLP) algorithms. Program components implementing machine learning models may be implemented in an Artificial Intelligence (AI) hardware accelerator, such as an FPGA or a graphics processing unit (GPU).

FIG. 1 shows multiple possible large language models, including components 116, 120, 121, 128, used to generate the data validation program. In further embodiments, the functions performed by the program components 116, 120, 121, and 128 may be performed in fewer large language models or in a greater number of large language models.

In certain embodiments, components, such as 116, 120, 121, 128, 140, implementing a machine learning model, may use machine learning and deep learning algorithms, such as decision tree learning, generative AI, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc.

For artificial neural network program implementations, the generative AI models 116, 120, 121, 128, 140 maybe trained using as input the input to these components to produce desired output for the inputs, i.e., ground truth output. In certain embodiments, the generative AI models may be trained using backward propagation to adjust weights and biases at nodes in a hidden layer to produce their output based on the received inputs. In backward propagation, biases at nodes in the hidden layer are adjusted accordingly to produce the output, such as the prompt answers, from input comprising the prompts, with specified confidence levels based on the input parameters. Backward propagation may comprise an algorithm for supervised learning of artificial neural networks using gradient descent to minimize the errors in predictions. Given a large language model artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error.

In further embodiments, techniques other than backward propagation may be used to train the generative AI models 116, 120, 121, 128, 140.

The arrows shown in FIG. 1 between the components in the memory 104 represent a data flow between the components.

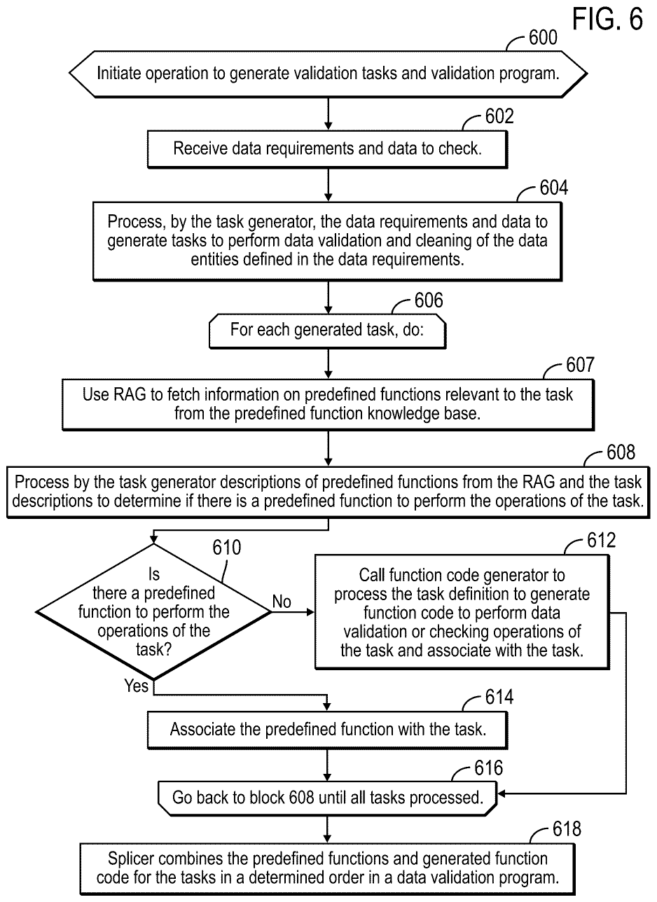

FIG. 6 illustrates an embodiment of operations to generate tasks to include in a data validation program. In certain embodiments, the operations of FIG. 6 may be performed by components of the validation program generator 106, such as, but not limited to components 116, 120, 121, 128. Upon initiating (at block 600) an operation to generate validation tasks and a validation program, data requirements, e.g., 200, and data to check, e.g., 112, are received (at block 602). A task generator, e.g., 120, processes (at block 604) the data requirements and data to generate tasks to perform data validation and cleaning of the data entities defined in the data requirements. A loop of operations is performed at blocks 606 through 616 for each generated task. At block 606, the RAG model 121 fetches information on predefined functions relevant to the task from the predefined function knowledge base 124. The task generator processes (at block 610) descriptions of predefined functions from the RAG model 121 and the task descriptions to determine if there is a predefined function to perform the operations of the task.

If (at block 610) there is no predefined function to perform the operations for the task being considered, a function code generator, e.g., 128, is called (at block 612) to process the task definition to generate function code to perform data validation or checking operations of the task and associate the generated function code with the task. If (at block 610) there is a predefined function to perform the operations of the task being considered, then that predefined function may be associated (at block 614) with the task.

After determining predefined functions or generating code for each task performed to validate and clean the data, a splicer program, e.g., 134, may combine (at block 618) the predefined functions and generated function code for the tasks in a determined order in a data validation program. This validation program may then execute against the data to check to validate the data and perform corrective transformations of the data as part of data cleaning. The validation program may be stored for later use to validate and clean data having the data requirements for which the data validation program is generated.

Described embodiments provide a computer architecture to use large language models to determine tasks to perform the validation and cleaning operations. Code is then determined from predefined functions or generated for the tasks to combine in a data validation program that may be repeatedly used to validate and clean data sets defined according to the data requirements for which the data validation program was generated.

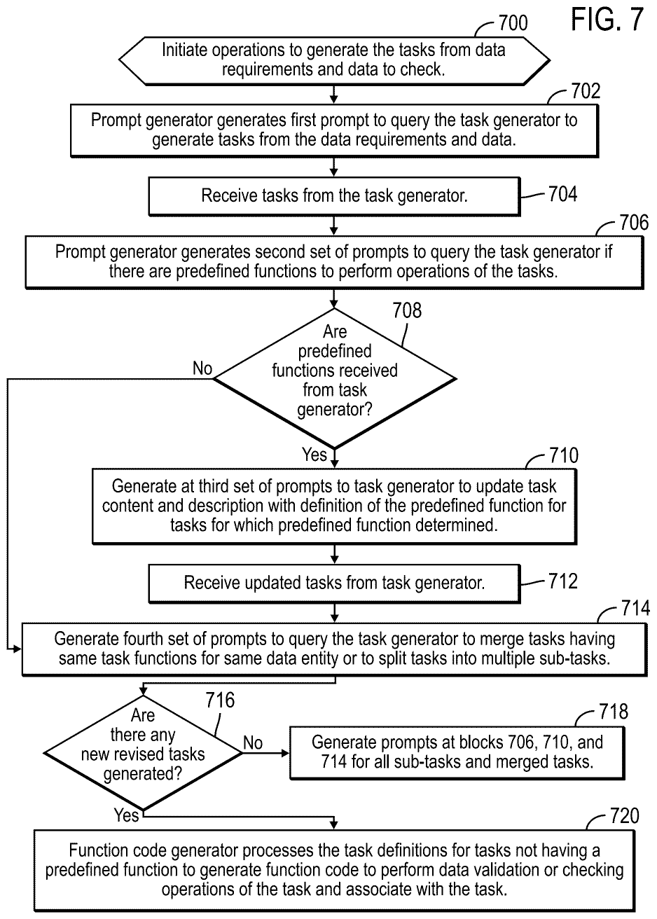

FIG. 7 illustrates a further embodiment for determining data validation and cleaning tasks using a prompt generator, e.g., 116, to issue a series of prompts to the task generator to generate tasks for which predefined functions and function code may be determined. In certain embodiments, the operations of FIG. 7 may be performed by components of the validation program generator 106, such as, but not limited to components 116, 120, 128. Upon initiating (at block 700) operations to generate the tasks from data requirements and data to check, the prompt generator generates (at block 702) a first prompt to query the task generator to generate tasks from the data requirements and data. Upon receiving (at block 704) tasks from the task generator in response to the first prompt, the prompt generator generates (at block 706) a second set of prompts to query the task generator if there are predefined functions to perform operations of the task. The RAG model 121 may fetch information on predefined functions from the predefined function knowledge base 124 relevant to the tasks. In the generative phase, the task generator 120 includes information on the predefined functions fetched by the RAG model 121 to include in the answer 122.

If (at block 708) the task generator returns predefined functions for at least some of the tasks, then the prompt generator may generate (at block 7 10) a third set of prompts to the task generator to update the task content and description with definitions of the predefined functions for tasks for which predefined function are returned.

Upon receiving (at block 712) updated task descriptions from the task generator or if no predefined functions are received (from the NO branch of block 708), the prompt generator may generate (at block 714) a fourth set of prompts to query the task generator to merge tasks having same task functions for a same data entity or to split tasks into multiple sub-tasks. A task may be split when the task is defined as performing multiple data validation and/or cleaning operations for one or more data entities that may be split into lower level tasks for each separate data entity.

If (at block 716) revised tasks are received from the task generator, including merged tasks and sub-tasks generated from tasks, then the prompt generator may generate (at block 718) prompts at blocks 706, 710, 714 for all the sub-tasks and merged tasks to determine predefined functions, update task descriptions, and further merge and split the revised tasks. The operations at block 718 would be recursively performed until there are no more returned revised tasks, e.g., tasks to merge or split into sub-tasks. If (at block 718) there are no new sub-tasks or other revised tasks, then the function code generator is called (at block 720) to process the task definitions for tasks not having a predefined function to generate function code to perform data validation or checking operations of the task and associate with the task. From block 720, control may proceed to block 618 in FIG. 6 to form the final data validation program.

With the embodiment of operations of FIG. 7, a prompt generator may generate a series of prompts to have the task generator generate tasks, determine predefined functions for tasks via a RAG model, update descriptions of tasks, and merge or split tasks into sub-tasks until a final set of tasks is obtained, each task providing operations for a specific data validation or cleaning operation with respect to a specific data entity. This provides an architecture for generating a data validation program having code for a series of tasks to perform data validation and cleaning for data having the specified data requirements.

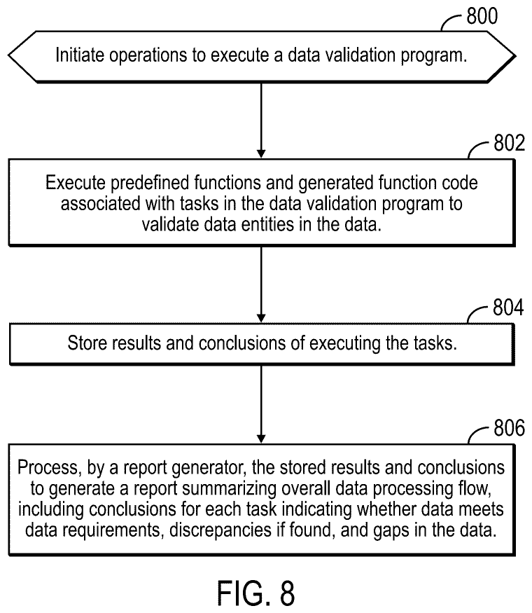

FIG. 8 illustrates an embodiment of operations to execute a data validation program generated according to the operations of FIG. 6 or 7. In certain embodiments, the operations of FIG. 8 may be performed by components of the data validation procedure, such as, but not limited to, components 108, 110, 140. Upon initiating (at block 800) operations to execute a data validation program, the data validation procedure, e.g., 110, may execute (at block 802) the predefined functions and generated function code associated with tasks in the data validation program to validate data entities in the data. The results of the data validation and cleaning may be stored (at block 804) along with conclusions about the execution of the tasks. A report generator, e.g., 140, may process (at block 806) the stored results and conclusions to generate a report in a human understandable form summarizing overall data processing flow, including conclusions for each task indicating whether data meets data requirements, discrepancies if found, and gaps in the data.

In various embodiments, the described methods are used to create natural language interfaces which it easier for non-technical users to interact with a data validation process. This process improves collaboration between system users of varying levels of technical ability/understanding.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

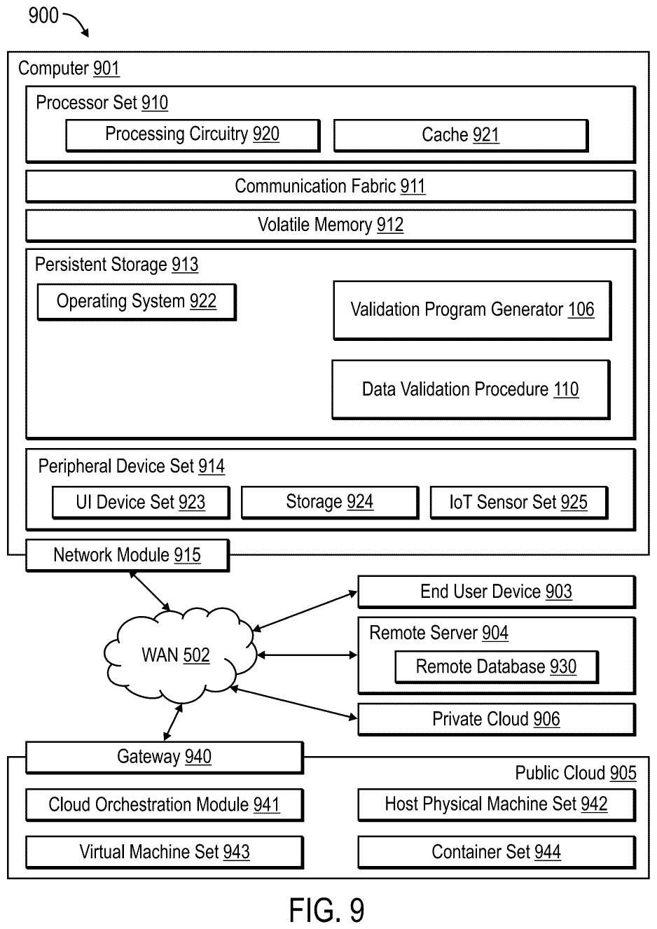

With respect to FIG. 9, computing environment 900 contains an example of an environment for the execution of at least some of the computer code involved in generating a data validation program and executing the data validation program to validate and clean data, including the validation program generator 106 and data validation procedure 110 described above. The computing environment 900 may further include, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922, validation program generator 106, and the data validation procedure 110, as identified above), peripheral device set 914 (including user interface (UI) device set 923, storage 924, and Internet of Things (IOT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods of the validation program generator 106 and data validation procedure 110 may be stored in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in the persistent storage 913, such as the validation program generator 106 and the data validation procedure 110, typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on. In certain embodiments, the EUD 903 may include the data validation procedure to validate data sets at the EUD 903.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

Cloud computing services and/or microservices (not separately shown in FIG. 9): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, and laptops), through the Internet, to the provider's systems, and back. In some embodiments, cloud services can be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs (Application Programming Interfaces). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on-demand, and virtual private networks.

The letter designators, such as i and j are used herein to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

1. A method, comprising:
receiving data requirements comprising a description of data to be validated;
processing, by artificial intelligence, the data requirements to generate task plans, wherein the task plans provide a description of data validation operations to perform on the data and comprise a first task plan and a second task plan, wherein the first task plan and the second task plan comprise different data validation tasks to perform;
processing, by the artificial intelligence, descriptions of predefined functions from a predefined function knowledge base to determine a predefined function that performs the data validation operations specified for the first task plan;
in response to determining that there is no predefined function in the predefined function knowledge base to perform the data validation operations of the second task plan, processing, by a function code generator, implementing artificial intelligence, the second task plan to generate function code to perform the data validation operations defined in the second task plan; and
executing the predefined function for the first task plan and the function code for the second task plan to validate the data.

2. The method of claim 1, wherein the task plans respectively comprise at least one member selected from a group consisting of a task name, task descriptions of execution methods to validate data, and task content including input and output definitions.

3. The method of claim 1, wherein the data requirements are selected from the group consisting of data structure definitions, field definitions, required fields, encoding formats, and a logical value range for the data.

4. The method of claim 1, wherein the artificial intelligence that processes the data requirements and generates the task plans comprises a first generative machine learning model.

5. The method of claim 4, wherein the function code generator comprises a second generative machine learning model that is separate from the first generative machine learning model.

6. The method of claim 4, wherein the first generative machine learning model uses retrieval augmented generation to fetch the descriptions of the predefined functions to determine the predefined function that performs the data validation operations specified for the first task plan.

7. The method of claim 4, further comprising:
generating a first prompt to the first generative machine learning model to generate task plans for data validation based on the data requirements;
generating a second prompt, wherein the second prompt is input to the first generative machine learning model to determine if one or more of the predefined functions is capable of performing a respective one of the task plans;
generating a third prompt to request the first generative machine learning model to update the first task plan according to descriptions of one or more predefined functions determined to perform the data validation operations of the first task plan;
generating a fourth prompt to revise the task plans by merging task plans performing same functions and by splitting task plans performing multiple operations into subtasks; and
generating the second, the third, and the fourth prompts with respect to merged tasks and determined subtasks until no further merged task plans and sub-task plans are determined.

8. The method of claim 1, further comprising:
processing the data requirements to generate prompts to input to the artificial intelligence, wherein the artificial intelligence processes the prompts to generate the task plans.

9. The method of claim 1, further comprising:
splicing the predefined function and the function code into a program, wherein the executing the predefined function and the function code comprises executing the program.

10. The method of claim 1, wherein the executing the predefined function for the first task plan and the function code for the second task plan further performs at least one operation selected from a group consisting of data cleaning, natural language processing to understand context to identify and correct errors and/or inconsistencies in the data, complex transformations of the data, providing natural language interfaces to allow users to interact with the data validation operations, generating documentation including descriptions of the data validation operations, and providing insights into logic of data validation operations.

11. A computer system, comprising:
a processor set;
one or more computer-readable storage media; and
program instructions stored on the one or more computer-readable storage media to cause the processor set to perform operations comprising:
receiving data requirements comprising a description of data to be validated;
processing, by artificial intelligence, the data requirements to generate task plans, wherein the task plans provide a description of data validation operations to perform on the data and comprise a first task plan and a second task plan, wherein the first task plan and the second task plan comprise different data validation tasks to perform
processing, by the artificial intelligence, descriptions of predefined functions from a predefined function knowledge base to determine a predefined function that performs the data validation operations specified for the first task plan;
in response to determining that there is no predefined function in the predefined function knowledge base to perform the data validation operations of the second task plan, processing, by a function code generator, implementing artificial intelligence, the second task plan to generate function code to perform the data validation operations defined in the second task plan; and
executing the predefined function for the first task plan and the function code for the second task plan to validate the data.

12. The computer system of claim 11, wherein the artificial intelligence that processes the data requirements and generates the task plans comprises a first generative machine learning model.

13. The computer system of claim 12, wherein the first generative machine learning model uses retrieval augmented generation to fetch the descriptions of the predefined functions to determine the predefined function that performs the data validation operations specified for the first task plan.

14. The computer system of claim 12, wherein the operations further comprise:
generating a first prompt to the first generative machine learning model to generate task plans for data validation based on the data requirements;
generating a second prompt, wherein the second prompt is input to the first generative machine learning model to determine if one or more of the predefined functions is capable of performing a respective one of the task plans;
generating a third prompt to request the first generative machine learning model to update the first task plan according to descriptions of one or more predefined functions determined to perform the data validation operations of the first task plan;
generating a fourth prompt to revise the task plans by merging task plans performing same functions and by splitting task plans performing multiple operations into subtasks; and
generating the second, the third, and the fourth prompts with respect to merged tasks and determined subtasks until no further merged task plans and sub-task plans are determined.

15. The computer system of claim 11, wherein the operations further comprise:
processing the data requirements to generate prompts to input to the artificial intelligence, wherein the artificial intelligence processes the prompts to generate the task plans.

16. A computer program product, comprising:
one or more computer-readable storage media; and
program instructions stored on the one or more computer-readable storage media to perform operations comprising:
receiving data requirements comprising a description of data to be validated;
processing, by artificial intelligence, the data requirements to generate task plans, wherein the task plans provide a description of data validation operations to perform on the data and comprise a first task plan and a second task plan, wherein the first task plan and the second task plan comprise different data validation tasks to perform;
processing, by the artificial intelligence, descriptions of predefined functions from a predefined function knowledge base to determine a predefined function that performs the data validation operations specified for the first task plan;
in response to determining that there is no predefined function in the predefined function knowledge base to perform the data validation operations of the second task plan, processing, by a function code generator, implementing artificial intelligence, the second task plan to generate function code to perform the data validation operations defined in the second task plan; and
executing the predefined function for the first task plan and the function code for the second task plan to validate the data.

17. The computer program product of claim 16, wherein the artificial intelligence that processes the data requirements and generates the task plans comprises a first generative machine learning model.

18. The computer program product of claim 17, wherein the first generative machine learning model uses retrieval augmented generation to fetch the descriptions of the predefined functions to determine the predefined function that performs the data validation operations specified for the first task plan.

19. The computer program product of claim 17, wherein the operations further comprise:
generating a first prompt to the first generative machine learning model to generate task plans for data validation based on the data requirements;
generating a second prompt, wherein the second prompt is input to the first generative machine learning model to determine if one or more of the predefined functions is capable of performing a respective one of the task plans;
generating a third prompt to request the first generative machine learning model to update the first task plan according to descriptions of one or more predefined functions determined to perform the data validation operations of the first task plan;
generating a fourth prompt to revise the task plans by merging task plans performing same functions and by splitting task plans performing multiple operations into subtasks; and
generating the second, the third, and the fourth prompts with respect to merged tasks and determined subtasks until no further merged task plans and sub-task plans are determined.

20. The computer program product of claim 16, wherein the operations further comprise:
processing the data requirements to generate prompts to input to the artificial intelligence, wherein the artificial intelligence processes the prompts to generate the task plans.
